(19) United States
(12) Patent Application Publication
(10) Pub. No.: US 2011/0320354 A1
(43) Pub. Date: Dec. 29, 2011

(54) SYSTEMS AND METHODS FOR ASYNCHRONOUS MOBILE AUTHORIZATION OF CREDIT CARD PURCHASES

(76) Inventor: Jonathan C. Coon, Austin, TX (US)

(21) Appl. No.: 12/824,974

(22) Filed: Jun. 28, 2010

(51) Int. Cl. G06Q 40/00; G06K 5/00

(52) U.S. Cl. 705/44; 235/380

(57) ABSTRACT

An exemplary system includes an asynchronous transaction authorization (“ATA”) subsystem configured to record prior approval of transaction parameters from the account holder(s) and approve a transaction with congruent parameters within a subsequent defined time period. If the parameters of a transaction attempt have not been previously authorized by the account holder(s), the parameters of the requested transaction are stored and the transaction is rejected. The ATA subsystem then queries all associated account or card holders (“ACHs”) providing the parameters of the attempted transaction. Upon authorization from the required ACHs, which is a predefined subset of all the associated ACHs, the purchaser and all ACHs may be notified of approval. The subsequent attempted transaction with congruent parameters will be authorized. Authorization will no longer be active after the subsequent transaction has been approved or a time, delta, has lapsed. In some examples, the authorization hierarchy is slightly different, e.g., domestic and commercial use.

### BACKGROUND

In 2009, forty-three percent of reported theft crimes were lost or stolen wallets, checkbooks, credit cards, and debit cards. Additionally, credit and debit card fraud is reported as the #1 fear of Americans. As a result, solutions to prevent credit and debit card fraud are critical to economic stability and consumer confidence.

Credit and debit card fraud is rampant, at least in part, due to the ease with which a criminal can access funds without the owner's authorization. A credit card can be charged without the cardholder's authorization simply by entering the card number and expiration date into a card processing terminal or processing application. With limited security features, it is extremely easy to obtain a cardholder's number and expiration date (from any charge receipt in a restaurant for instance) and to charge that card without the owner's authorization.

Even more unfortunate, when a cardholder's account is used without the cardholder's authorization, the burden rests with the cardholder to dispute the charge and fill out paperwork to ensure that the cardholder does not have to pay for the unwanted or fraudulent activity. Often, the notice that a fraudulent charge has taken place will not be discovered until days or weeks after the activity has occurred.

The latency in receiving a notice of fraudulent charge activity is amazing when considering the technology that is readily available to most people by way of cell phones, handheld computing devices, laptops, and the like. For example, in 2007, nearly eighty-five percent of Americans owned a cellular phone, and the percentage has continued to rise. Most cell phones are sophisticated embedded devices, capable of sending and receiving data. Development of new applications for the higher end cell phone models has led to great innovation. However, many users use phones that are not powerful enough to run such applications. Consequently, credit card fraud solutions using other mobile computing features have not proven to be effective, nor have they been widely adopted.

### SUMMARY

A system for asynchronous mobile authorization of credit card purchases includes, according to one exemplary embodiment, an asynchronous transaction authorization (“ATA”) subsystem configured to selectively approve or reject credit card transactions based on a number of parameters. According to one exemplary embodiment, pre-authorization for a credit card transaction may be obtained by submitting the anticipated transaction cost to the ATA prior to purchasing the items. According to this exemplary embodiment, the account holder may pre-authorize a specific transaction amount such that if a transaction is executed for the pre-authorized price, within a pre-defined amount of time, the transaction will be approved. Furthermore an account holder may supply the ATA with a range of anticipated prices rather than an exact transaction amount, in order to obtain pre-approval. Yet further, pre-authorization may be requested by an authorized card holder to allow or activate the card for an anticipated transaction. Pre-authorization would permit the execution of a transaction during a first attempt for a transaction that exceeds a pre-determined threshold that would typically require authorization. Furthermore, a card issuing bank may incorporate the present exemplary systems and methods and provide additional information, including a verification that a desired transaction would be approved, thus further eliminating potential issues and embarrassment caused by an overdrawn account.

In another exemplary embodiment, the asynchronous transaction authorization (“ATA”) subsystem is configured to reject an initial transaction request from a merchant if it exceeds a predetermined threshold amount that has not been pre-approved. The parameters of the requested transaction are stored by the ATA subsystem which then queries all associated account or card holders providing the parameters of the attempted transaction and requests authorization. Upon authorization from a sufficient number of required associated account or card holders, which is a predefined subset of all the associated card holders, the purchaser and all associated account or card holders may be notified of approval. The subsequent attempted transaction with congruent parameters will be authorized. Authorization will no longer be active after the subsequent transaction has been approved or a time, delta, has lapsed.

In yet another exemplary embodiment, the threshold amount provided in the system may be a cumulative amount determined by a period of time rather than a single transaction.

### BRIEF DESCRIPTION OF THE DRAWINGS

The accompanying drawings illustrate various embodiments of the principles described herein and are a part of the specification. Together with the following description, the drawings demonstrate and explain the principles of the exemplary system and method. The illustrated embodiments are merely examples and do not limit the scope of the disclosure.

FIG. 1 is a block diagram illustrating an exemplary asynchronous mobile authorization system, according to principles described herein.

FIG. 2 is a block diagram illustrating an exemplary asynchronous mobile authorization system, according to principles described herein.

FIG. 3 is a block diagram illustrating an exemplary mobile communication system using the SMS, according to principles described herein.

FIG. 4 is a block diagram illustrating an exemplary mobile communication system using a proprietary messaging and communication network, according to principles described herein.

FIG. 5 is a flowchart illustrating an exemplary asynchronous mobile authorization process, according to principles described herein.

FIG. 6 is a flowchart illustrating an exemplary asynchronous mobile authorization process, according to principles described herein.

FIG. 7 is a flowchart illustrating an exemplary asynchronous mobile authorization process, according to principles described herein.

FIG. 8 is a flowchart illustrating an exemplary asynchronous mobile authorization process, according to principles described herein.

Throughout the drawings, identical reference numbers designate similar, though not necessarily identical elements.

### DETAILED DESCRIPTION

The present exemplary system and method combat credit card and debit card fraud by leveraging widely adopted wireless communication protocols. Specifically, according to one exemplary embodiment, the present system and method utilizes cellular phones and the short message system (“SMS”) to asynchronously authorize credit and debit card transactions. As used herein, the terms “debit card” and “credit card” shall be used interchangeably to refer to any numerically based instrument that is used for electronic purchase.

The present exemplary system and method also creates further flexibility for credit card use. For instance, a parent may want their child to have a credit card in their wallet at all times in case of an emergency. However, the parent will also likely want to scrutinize any transactions paid for with the card. Similarly, a parent may want their children to learn how to manage an account and to learn the advantages and disadvantages of using credit cards. The present exemplary system and method for asynchronous mobile authorization of credit card purchases enables a parent to be notified of attempted transactions of a designated monetary amount and to authorize or deny the transactions at any location, including locations remote from the point of sale.

Additionally, the present exemplary system and method provides one or more account holders the ability to remotely authorize transactions using their cellular phones. This technique not only reduces fraud and the opportunity for fraudulent activity, but can also be used as a tool for fiscal accountability, where card holders that have previously made poor impromptu purchases or have accrued substantial credit card debt are required to obtain the authorization of at least one other individual prior to completing a transaction that meets a designated price threshold. As will be detailed below, the authorization provided by at least one other individual may be asynchronous to the desired transaction in that it may be provided in a time period prior to a desired transaction or immediately after a desired transaction exceeding pre-defined limits has been denied.

The present specification details exemplary systems and methods for asynchronous mobile authorization of credit card purchases. The systems and methods described herein enable credit card holders, or the account holders of the credit card, to asynchronously authorize credit card purchases in order to protect assets and monitor account behavior, while minimizing cardholder inconvenience, embarrassment, or delay.

While traditional systems for credit card control and/or authorization are dependent on proprietary software being resident on the mobile device and only allow for synchronized authorization at the point of sale, the present exemplary system and method allows account holders to authorize purchases at either the point of sale or at a remote location, thereby adding convenience to the cardholder. Furthermore, the present exemplary system and method provides protection from credit card theft, identity theft, and/or other fraudulent schemes intended to make transactions without the card or account holders' permission. Moreover, the present exemplary system and method allows for multiple account holders to monitor and approve transactions, which is useful in both domestic and commercial settings. Alternate configurations may also include, but are in no way limited to, a tiered authorization structure based on the total purchase price, purchaser, card holder, etc.

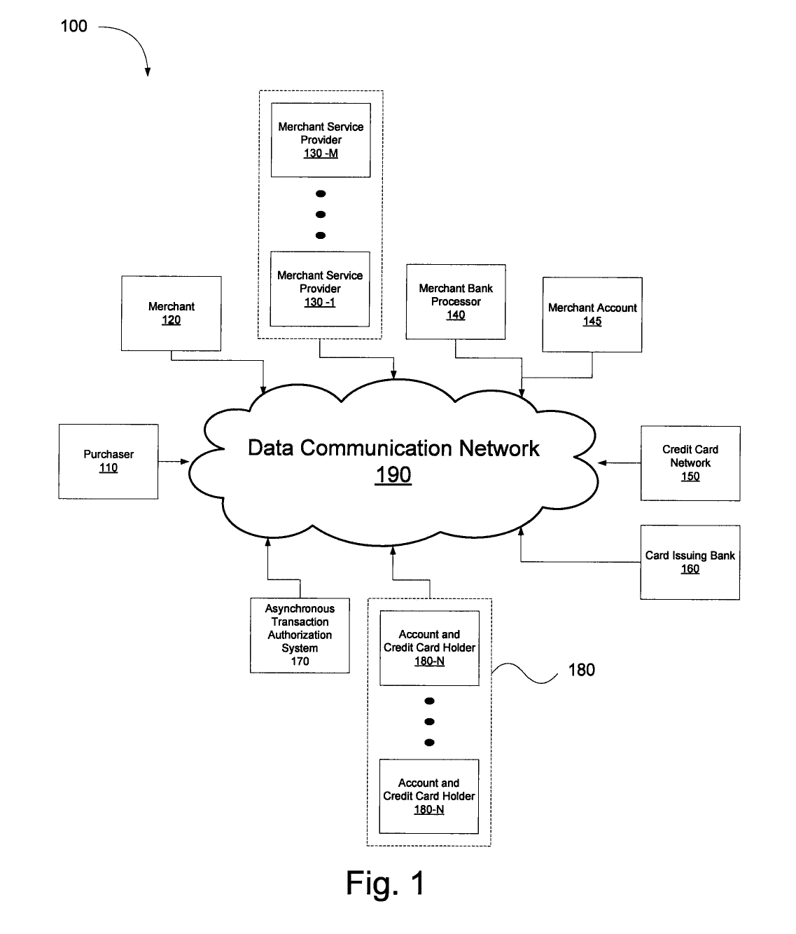

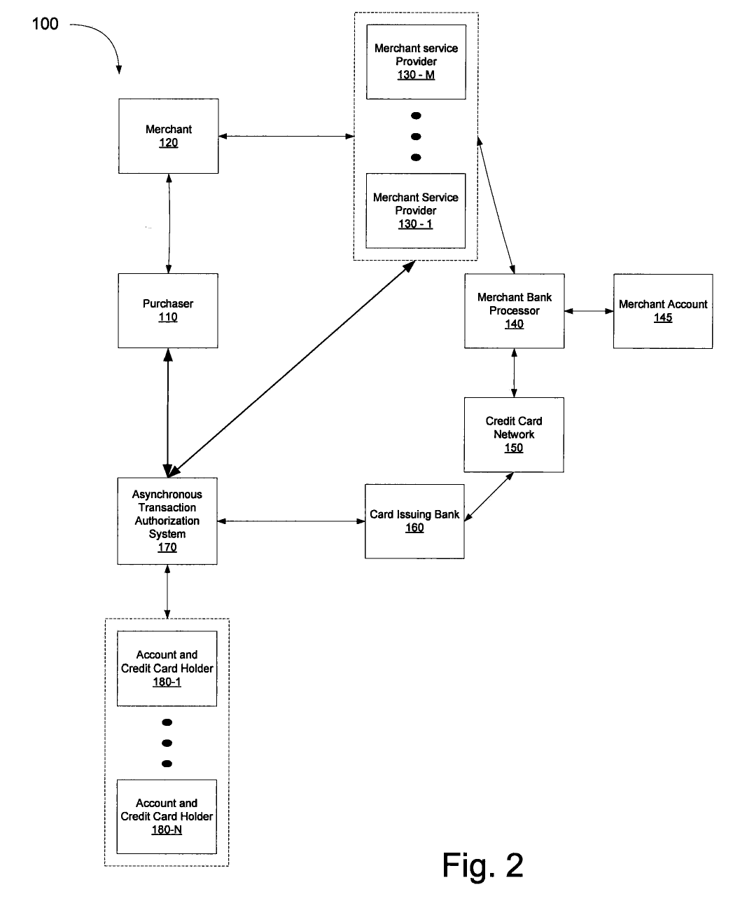

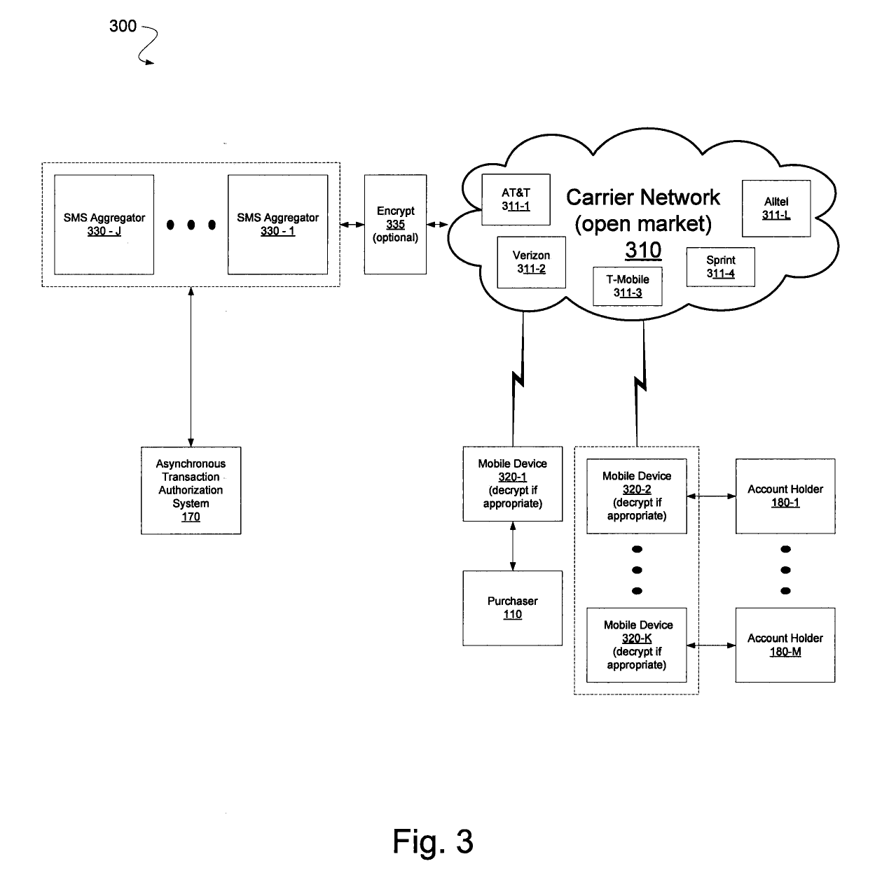

In a domestic setting, as illustrated in FIGS. 1 and 2, a purchaser (110) may be any person that is entrusted with a credit card, including but not limited to a child. According to one exemplary embodiment, the guardians and/or account holders (180) of the card entrusted to the purchaser (110) may require that any purchases over a pre-determined amount, such as fifty dollars, be authorized by an appropriate number of account holders (180). According to the present exemplary system and method, when a purchaser (110), which may also be an account holder (180), anticipates making a purchase that exceeds the pre-determined amount, pre-authorization of the desired transaction may be secured using the present exemplary systems and methods. According to this exemplary embodiment, the purchaser may first obtain the anticipated transaction total, either directly from the merchant (120) or via a separate purchase price accumulator. The purchaser (110) could then, using any number of wireless communication devices including, but in no way limited to an application on a smart phone (ACHD (320; FIG. 3)) or text messaging (the SMS (300; FIG. 3)) on a non-smartphone, obtain pre-authorization of the desired transaction, using the exemplary systems and methods detailed below.

Furthermore, when obtaining pre-authorization of an anticipated transaction, the account holder(s) (180) or purchaser (110) may enter a desired transaction range for approval, rather than a specific amount. The ability to request approval for a desired transaction range adds the convenience of perhaps not requiring all the desired items to be rung up at a register or, for instance, if an unknown amount will be left for a tip or other situation where the exact transaction amount is unknown. According to this exemplary embodiment, receipt of the transaction request by the exemplary system would cause a notification to be transmitted to the account holder(s) (180). The purchaser (110) may also have the ability to include a note that will be provided to the account holder(s) (180) along with the purchase authorization request, e.g., “buying school supplies at Staples. I need a new printer.” The amount requested, and the note may be presented to the account holder(s) (180) for pre-authorization according to the exemplary systems and methods detailed below.

After the account holder(s) (180) approve the transaction via a responsive sms text message or other similar feature, notification of approval may be sent via text message to the other account holder(s) (180) and/or the purchaser (110). After a predefined number of account holders (180) have granted approval, the card holder/purchaser (110) may be sent a notification via text message that transaction has been authorized.

Alternatively, According to the present exemplary embodiment, when the merchant (120) is requested to initiate a charge with the entrusted credit card and attempts to complete the transaction that exceeds a predefined threshold, e.g., fifty dollars, and no pre-authorization has been obtained, the transaction is initially declined, and submission results are returned to merchant. According to this exemplary embodiment, the failed transaction exceeding the predefined threshold initiates the transmission of a message to the purchaser (110), such as a text message, notifying the purchaser (110) that authorization of the declined charge is pending. Simultaneously, according to one exemplary embodiment, the account holder(s) (180) also each receive a text message, which may include, but is in no way limited to, the transaction parameters of the recently declined transaction and a query for authorization of a subsequent transaction. The transaction details provided to the account holder(s) (180-1-180-N) may include, but are in no way limited to, the merchant's (120) id or name, the charged card number, card holder name, and/or transaction price. The text message may also optionally include a request for a keyword that must be in the account holder's response to approve the transaction.

Again, after the account holder(s) (180) approve the transaction via a responsive sms text message or other similar feature, notification of approval may be sent via text message to the other account holder(s) (180) and/or the purchaser (110). After a predefined number of account holders (180) have granted approval, the card holder/purchaser (110) may be sent a notification via text message that transaction has been approved.

The purchaser (110) can then instruct the merchant (120) to submit the transaction for a second time. The transaction is again requested by the merchant (120) via a credit card terminal or other computing device transmitting transaction parameters to an appropriate receiving system. Once the follow-up transaction request is submitted, the charge will be approved and the sale consummated because the authorization has been given by an appropriate number of account holders (180). Transaction parameters may include any number of descriptive information related to the desired transaction including, but in no way limited to the merchant id and name, amount of desired transaction and the like. Many times merchants will incorporate large computing systems including multiple processors and thus multiple unique merchant identifiers across the multiple processors. Consequently, merchant identifiers may be correlated with the merchant's (120) name for matching authorization with the second transaction request.

Thus, the present exemplary systems may be used to track authorized purchases by family members. It may also be used to prevent fraudulent purchases above a designated threshold by those who have stolen either an account holder's (180) card or card information.

These and other uses and benefits of the exemplary systems and methods described herein will become apparent upon consideration of the following examples.

### I. Exemplary System View

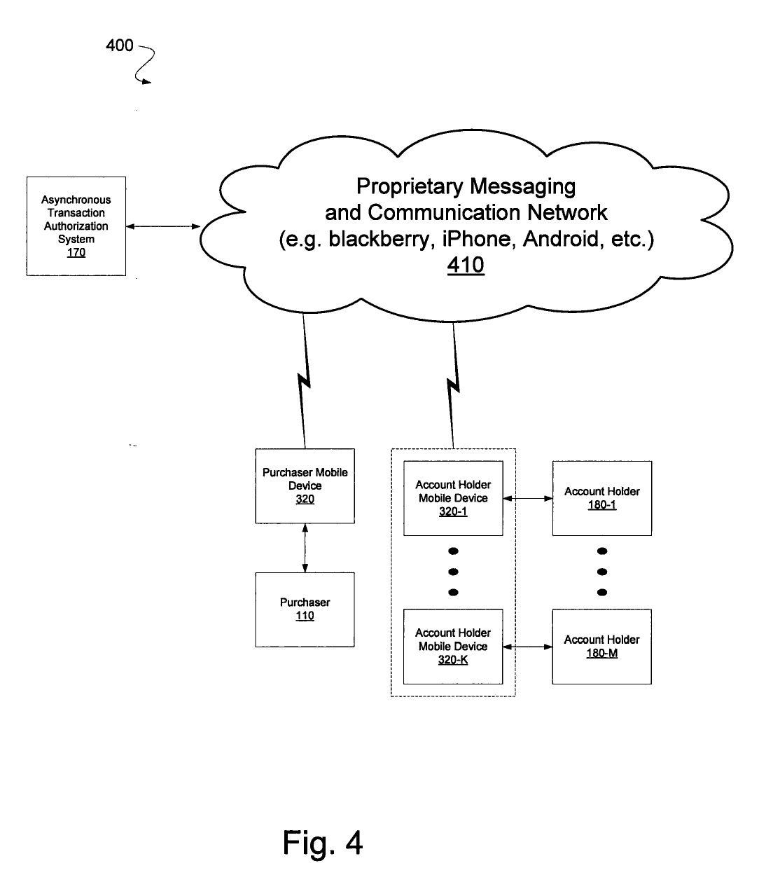

FIG. 1 and FIG. 2 illustrate exemplary asynchronous mobile authorization systems (100) incorporating the present exemplary system and method for asynchronous mobile authorization. As shown in FIG. 1, the present exemplary system (100) may include a purchaser (110), a merchant (120), a merchant service provider (“MSP”) (130-1-130-M) (collectively referred to as “MSPs (130)”), a merchant bank processor (“MBP”) (140), a credit card network (“CCN”) (150), a card issuing bank (“CIB”) (160), an asynchronous transaction authorization subsystem (“ATA”) (170), and account or card holder (“ACH”) devices (180-1 through 180-N) (collectively “ACHs (180)”). In some examples, all persons, modules, and subsystems may communicate using any known communication technologies, devices, media and protocols supportive of remote communications, including but not limited to, transmission media, communications devices, Transmission Control Protocol (“TCP”), Internet Protocol (“IP”), File Transfer Protocol (“FTP”), telnet, Hypertext Transfer Protocol (“HTTP”), socket connections, packet-switching technologies, circuit-switching technologies, wireless communications technologies (e.g., cellular telephone and wireless access technologies), and any other suitable communications technologies. The purchaser (110), CCN (150), CIB (160), and ACHs (170) may communicate over any number of technologies including, but in no way limited to, the SMS (300; FIG. 3) and proprietary messaging and data systems (400; FIG. 4).

Through ACH devices (180-1-180-n), e.g., mobile phones, the purchaser (110) and ACHs (180) may be provided with notification of pre-purchase authorization requests, attempted purchases, notification of authorization, notification of each party providing authorization, providing authorization, notification of authorization expiration, and submitted transactions via the ATA (170). The results may be published to any appropriate combination of the purchaser (110), merchant (120), MSPs (130), MBP (140), CCN (150), CIB (160), ATA (170), ACHs (180), and the ACHDs (320). Elements and functions of the exemplary system (100) of FIG. 1 will now be described in additional detail below.

A. Purchaser (110)

The purchaser (110) illustrated in the system of FIG. 1 may be any person attempting to purchase goods or services from a merchant (120) with a credit or debit card. According to one exemplary embodiment, a purchaser (110) includes, but is in no way limited to, an account and credit card holder (180), an authorized agent of an ACH (180), or a fraudulent user of a credit card owned by ACHs (180), and may be initiated via online purchases, in-store purchases, and/or remote caller purchases.

B. Merchant (120)

A merchant (120) may be any physical, on-line, phone, or otherwise accessible entity that sells goods or services to the purchaser (110). Popular merchants include, by way of example only, Wal-Mart Stores, Inc., Foot Locker, Inc., and Amazon.com, Inc. According to one exemplary embodiment, a merchant is registered, and makes transactions through, one or more MSPs (130-1-130-M). Prior to accepting credit card transactions, a merchant (120) creates a merchant bank account (145) and then registers the account with one or more merchant MSPs (130-1-130-M). Once established, the merchant (120) can submit a credit card transaction to the MSP (130-1-130-M) on behalf of a customer via secure Web site connection, retail store, MOTO center or wireless device.

A merchant (120) may include or be associated with one or more networks suitable for carrying communications between the merchant (120), and the MSP (130-1-130-M). For example, the merchant (120) may be communicatively coupled to the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the merchant (120) and the MSP (130-1-130-M).

C. Merchant Service Providers (“MSP”) (130-1-130-M)

An MSP (130-1-130-M) provides an interface for real-time credit card processing to a merchant (120). Examples of some popular MSPs (130-1-130-M) include, by way of example only, Authorize.Net, Paypal, and Beanstream Internet Commerce Corp. Many banks that provide merchant accounts also operate as merchant service providers. An MSP (130-1-130-M) receives secure transaction information from a merchant (120) and passes it via a secure connection to the merchant bank processor (140). The MSP (130-1-130-M) may be communicatively coupled to one or more networks suitable for carrying communications between the merchant (120), and the MBP (140). For example, the MSP (130) may be communicatively coupled to any network including, but in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the merchant (120) and the MBP (140).

D. Merchant Bank's Processor (“MBP”) (140)

As illustrated in FIG. 1, the Merchant Bank's Processor (140) is associated with a bank and provides access to a merchant account (145). Popular MBPs (140) include, by way of example only, Wells Fargo, N.A., Citigroup, Inc., and many other companies which may provide an interface for real-time credit card processing. Many banks that provide merchant accounts are also MBPs (140). The MBP (140) receives a transaction request and submits the transaction to the CCN (150) for authorization and processing. The MBP (140) may be communicatively coupled to one or more networks suitable for carrying communications between the MSP (130), and the CCN (150). For example, the MBP (140) may be communicatively coupled to, but is not limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the MSP (130) and the CCN (150).

E. Merchant Bank Account (145)

The popular merchant banks detailed above, including Wells Fargo, N.A., Citigroup, Inc., and many other companies, offer merchant bank accounts (145) that provide similar features and services, when compared to personal bank accounts, but also typically enable real-time credit card deposits and withdrawals. A merchant bank account (145) may be established and be configured to be accessed and communicate via one or more networks suitable for carrying communications between it and the MBP (140) including, but in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between it and the MBP (140).

F. Credit Card Network (CCN) (150)

As illustrated in FIG. 1, the CCN (150) is a system of financial entities that communicate to manage the processing, clearing, and settlement of credit card transactions. The CCN (150) routes a received transaction to the Customer's CIB (160) for approval and further processing. The system of financial entities that function and/or operate in the credit card network (150) may include, but are in no way limited to, Visa, Inc., MasterCard, Inc., and American Express Company. According to one exemplary embodiment, the CCN may be a processor, a server, or any number of dedicated servers that receive credit card transaction requests, identify the card issuing bank associated with the credit card transaction request, and facilitate communication of the credit card transaction request with the card issuing bank (160). Communication between the CCN, and any other entity illustrated in FIG. 1 may be accomplished via one or more networks suitable for carrying communications including, but in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the elements illustrated in FIG. 1.

G. Card Issuing Bank (“CIB”) (160)

A CIB (160) is any financial institution, including banks, credit unions, corporations, stores, and the like, which issue the credit card to the ACH (180). Popular CIBs (160) include Wells Fargo, N.A., Citigroup, Inc., JPMorgan Chase & Co., and any other companies that provide credit cards from Visa, Inc., MasterCard, Inc., and American Express Company. Prior to the current system, the CIB (160) was one of the only entities in the transaction process which approved or declined a requested transaction based on the customer's available funds. The CIB would then historically pass the transaction results back to the CCN (150) for further action and/or inaction. In the present exemplary system and method presented, the CIB (160) still approves or declines settlement of credit card transactions, however before final approval, the CIB (160) routes the transaction to the ATA (170) for initial approval.

Similar to the communication details mentioned above, the CIB (160) may be communicatively coupled to one or more networks suitable for carrying communications between the CCN (150) and the ATA (170). For example, the CIB (160) may be communicatively coupled to, but is not limited in its communication connection to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the CCN (150) and the ATA (170).

H. Asynchronous Transaction Authorization Subsystem (“ATA”) (170)

According to one exemplary embodiment of the present exemplary system and method illustrated in FIG. 1, an asynchronous transaction authorization subsystem may form an integral component of the asynchronous mobile authorization systems (100). According to the present exemplary system, the ATA (170) may be configured to give approval of a submitted or anticipated transaction that exceeds a predefined threshold only after sufficient ACHs (180) have given approval. The ATA (170) may be included in or reside with, but is in no way constrained to exist within the CCN (150) or the CIB (160), as an inline filter before or after the CCN (150) or the CIB (160). Alternatively, the ATA may exist as a third-party system interfacing with any modules or systems within the credit card authorization process (100) and acting as a clearing house for various transactions based on the thresholds provided.

According to one exemplary embodiment, regardless of the physical location of the ATA, the ATA (170) also may include, but is not limited to one or more servers with software to interface with one or more CIBs (160), one or more SMS aggregators, and electronic storage devices.

Accordingly, those skilled in the art will recognize that the processes described herein may be implemented at least in part as instructions executable by one or more computing devices. In general, a processor (e.g., a microprocessor) receives or otherwise accesses instructions, e.g., from a data storage device, memory, computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media, volatile media, and transmission media. Non-volatile media may include, for example, optical or magnetic disks and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, light waves, and electromagnetic emissions, such as those generated during radio frequency (“RF”) and infrared (“IR”) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, solid state drives, any other memory chip or cartridge, or any other medium from which a computer can read.

Furthermore, as illustrated in FIG. 1, the ATA (170) may communicate with the present exemplary system via a data communication access which may include, but is in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, SMS, multimedia messaging service (“MMS”), simple mail transfer protocol (“SMTP”), proprietary communication network via mobile device manufacturer (e.g., iPhone, Blackberry, and Android) proprietary networks for sending and receiving message or instructions (410) and any other communications networks capable of carrying communications between the purchaser (110), CCN (150), CIB (160) and the ACH (180).

I. Account or Authorized Card Holders (“ACH”) (180)

As noted previously, an account or authorized card holder is any person that owns or shares ownership of an account and is at least partially responsible for its funds. The ACH (180) may, but is in no way limited to, interface through the SMS (300; FIG. 3), PMMCN (410; FIG. 4), or ACHD (320; FIG. 3). The ACH may, but is in no way limited to communication with any module, subsystem, or class within the system (100).

As noted above, a mobile phone or any computing device including a hand-held computing device may be used to facilitate the access of ACH to the system (100). According to one exemplary embodiment, the ACH (180) interacts with the present system (100) via SMS and/or MMS messaging. FIG. 3 is an exemplary cellular communication system (300) configured to send and receive SMS and MMS messages via the carrier network in order to facilitate the present exemplary system and method. As shown in FIG. 3, the cellular communication system (300) may include a carrier network (310) configured to communicatively couple a purchaser (110), an asynchronous transaction authorization subsystem (“ATA”) (170), account or card holder (“ACH”) devices (180-1 through 180-N) (collectively “ACHs (180)”), and mobile device (320-1 through 320-K) (collectively “mobile devices (320)”). In some examples, all persons, modules, and subsystems may communicate using any known communication technologies, devices, media and protocols supportive of remote communications, including but not limited to, transmission media, communications devices, Transmission Control Protocol (“TCP”), Internet Protocol (“IP”), File Transfer Protocol (“FTP”), telnet, Hypertext Transfer Protocol (“HTTP”), socket connections, packet-switching technologies, circuit-switching technologies, wireless communications technologies (e.g., cellular telephone and wireless access technologies), and any other suitable communications technologies. The cellular communication system (300) will be discussed below.

J. Mobile Device (“ACHD”) (320)

According to one exemplary embodiment, the account or authorized card holder device (320) illustrated in FIG. 3 is any mobile computing device which may include, but is not limited to a blackberry, an iPhone, a PDA, a Nintendo DS, or any other mobile device that can send and receive messages over the SMS (300) or propriety messaging network (400). The ACHD (320) may have access to one or more networks suitable for carrying communications between it and the ATA (170). For example, the ACHD (320) may have access to, but is not limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, SMS, MMS, SMTP, and any other communications networks capable of carrying communications between it and the ATA (170), the cellular communication system (300), PMMCN (410), or ACH (180).

K. Carrier Network (Open Market) (310)

According to the exemplary illustrated embodiment, the present exemplary system may facilitate communication between the purchaser, the ATA (170) and the ACH (180) via a carrier network (310). According to one exemplary embodiment, the carrier network may include, but is in no way limited to, cellular service providers, e.g., AT&T (311-1), Verizon (311-2), T-Mobile (311-3), Sprint (311-4), and Alltel (311-L). The carrier network is a system of cellular providers which are responsible for connection, delivery of data, and service for one or more ACHDs (320). The carrier network (180) may include one or more networks suitable for carrying communications between the ACHDs (320) and the SMS Aggregators (330). For example, the carrier network (310) may access the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, SMS, MMS, SMTP, and any other communications networks capable of carrying communications between the ACHDs (320) and the SMS Aggregators (330). Interfacing directly with the carrier network can be both costly and time consuming and therefore, may be abstracted away, through SMS aggregators (330).

L. SMS Aggregator (330)

SMS aggregators, such as CellTrust, Inc., Click-a-tell (Pty) Ltd., and MobyQ, LLC provide an interface for computing devices to send and receive messages via the SMS, without direct connection to the carrier network (310). These services typically offer high throughput and statistics that would normally be unavailable through an ACHD (320). An SMS aggregator (330) may communicate via any network suitable for carrying communications including, but in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, SMS, MMS, SMTP, and any other communications networks capable of carrying communications between the ATA (170) and the ACHDs (320).

M. Encrypt (335)

According to one exemplary embodiment, in order to maintain security of the present exemplary system, the data communications that are transmitted between the various components of the system (100) are encrypted. The encryption and decryption of a message via the SMS, or any message over the carrier network (310) are typically processed independently. The SMS protocol does not typically implement any additional encryption to secure messages between ACHDs (320), SMS aggregators (330), or the ATA (170). Prior work using encryption over SMS or the PMMCN (410) has been documented. It is an industry standard in the financial sector to incorporate encryption mechanisms between mobile/remote access points, therefore the ATA system may, but is not required to do so as well.

FIG. 4 illustrates an exemplary proprietary mobile data and communication system (400), according to one exemplary embodiment. As shown in FIG. 4, the proprietary mobile data and communication system (400) may include a purchaser (110), an asynchronous transaction authorization subsystem (“ATA”) (170), account or card holder (“ACH”) (180-1 through 180-N) (collectively “ACHs (180)”), device (320-1 through 320-K) (collectively “mobile devices (320)”), and a proprietary mobile messaging and communication network (410). In some examples, all persons, modules, and subsystems may communicate using any known communication technologies, devices, media and protocols supportive or remote communications, including but not limited to, transmission media, communications devices, Transmission Control Protocol (“TCP”), Internet Protocol (“IP”), File Transfer Protocol (“FTP”), telnet, Hypertext Transfer Protocol (“HTTP”), socket connections, packet-switching technologies, circuit-switching technologies, wireless communications technologies (e.g., cellular telephone and wireless access technologies), and any other suitable communications technologies. The proprietary mobile data and communication system (400) will be discussed below.

N. Proprietary Mobile Messaging and Communication Network (“PMMCN”) (410)

The proprietary mobile messaging and communications network (410) illustrated in FIG. 4 enables the present exemplary system and method to be conducted over a proprietary network. Specifically, the PMMCN (410) is a system of proprietary messaging and data service providers which are responsible for connection, delivery, and service of one or more ACHDs (320). According to one exemplary embodiment, the PMMCN (410) includes, but is in no way limited to mobile device developers and manufacturers, e.g., Apple (iPhone and iPod Touch), Blackberry, Google (Android), Nintendo (Nintendo DS), etc that enable communication between devices. The use of the PMMNCN (410) allows the ATA to communicate with proprietary applications which run locally on an ACHD (320), but may provide enhanced functionality not normally available through the SMS. Such applications and features may include, but are in no way limited to, bar codes scanners implemented in iPhone and Android applications, as will be described in further detail below.

### II. Exemplary Process View

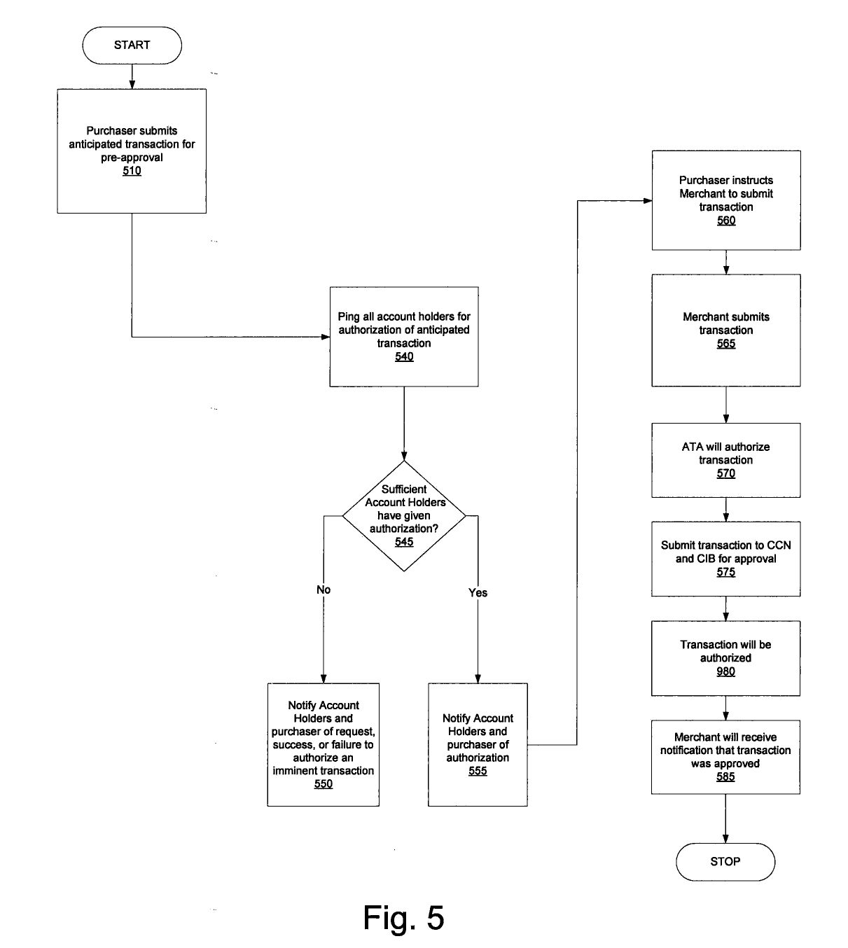

FIG. 5 illustrates an exemplary process for pre-authorizing a transaction that exceeds a predetermined threshold using the ATA system, according to one exemplary embodiment. While FIG. 5 illustrates exemplary steps according to one embodiment, other embodiments may selectively omit, add to, reorder, and/or modify the steps shown in FIG. 5.

As shown in FIG. 5, when a purchaser (110) has identified a desired transaction that exceeds the predetermined threshold amount, the purchaser seeks pre-approval of the desired transaction by submitting the transaction amount to the present exemplary system (step 510). Optionally the purchaser (110) may submit a range, or a series of prices for which the sum should equal the amount of the anticipated transaction. Once the transaction amount has been received by the ATA (170), the ATA will ping the ACHs (180) for approval (step 540). As noted above, when the ACHs (180) are contacted for their approval of a proposed transaction, any variation of information may be provided. According to one exemplary embodiment, the transaction authorization request may include any combination of, but is in no way limited to, the transaction amount, merchant information, a description of products being purchased with the transaction, a personalized message, and the like. In response to the ping sent to the ACHs (180), the ATA may initiate a timed session wherein approval must be provided by a predetermined number of ACHs (180) or the ATA will decline the pre-authorization.

Regardless of whether or not a session is initiated, the ATA will monitor responses and determine if sufficient ACHs (180) have provided authorization (step 545). According to this exemplary embodiment, account holders may establish a pre-determined number of ACH authorizations that are needed to authorize a transaction over the pre-determined threshold. Based on the pre-determined ACH authorization level, the ATA (170) verifies that sufficient ACH approvals have been received (step 545). If an insufficient number of ACH approvals have been received by the ATA (No, step 545), the ATA notifies the ACHs (180) and the purchaser (110) that the pre-authorization has been declined (step 550). According to one exemplary embodiment, the ATA (170) may, if insufficient ACH authorizations have been received, remind non-responsive ACHs (180) of the request and responses by other ACHs (180). Upon subsequent ACH responses, step 545 can repeated, and step 550 will be repeated until all required ACHs (180) have given approval, declined, or the session times out.

If sufficient ACHs (180) have given authorization (Yes, step 545), the ACHs and the purchaser are notified of the pre-authorization (step 555). According to one exemplary embodiment, if the ATA is implemented as part of the CIB (160), the CIB (160) may, in addition to returning information related to the pre-approval of the transaction by the ACHs (180), return information related to whether the anticipated transaction would be approved, denied, or create an overdraft situation based on a lack of funds or other management reason the CIB (160) might provide.

Continuing with FIG. 5, once the purchaser (110) receives notification that the anticipated transaction is authorized (step 555), the purchaser (110) will instruct the merchant (120) to submit a transaction (step 560). When the transaction is submitted by the merchant through the MSP (step 565), the submitted transaction parameters should correspond to the transaction details used for pre-authorization. If the parameters are not substantially the same, or are not submitted within a predefined amount of time from the pre-authorization notification, the transaction will also be declined.

If, however, the parameters of the merchant submitted transaction are sufficiently similar to the originally submitted pre-authorization transaction information (as compared by the ATA), and within a designated period of time, the ATA will authorize the transaction (step 570) and allow the CCN (150), CIB (160), or any other module or subsystem interfacing with the ATA (170) to verify that all other parameters are in line for approval of the transaction (step 575). While the present exemplary system is described as requiring ATA approval of transaction exceeding the predetermined amount prior to passing the transaction on to the CCN (150) and/or CIB (160), such as if the ATA functioned as a standalone clearinghouse, The ATA (170) may be resident with the CCN or CIB, approval by the ATA may occur either prior to or after approval by the CCN and/or CIB.

Once approval is obtained by the ATA, the CCN, and the CIB, the transaction will be authorized and funds may be transferred to merchant account (step 580). Accordingly, the transaction will be approved at the point of sale and the merchant (120) will receive notification that the transaction has been approved and/or completed (step 585). Once completed, the purchaser may obtain the items being purchased.

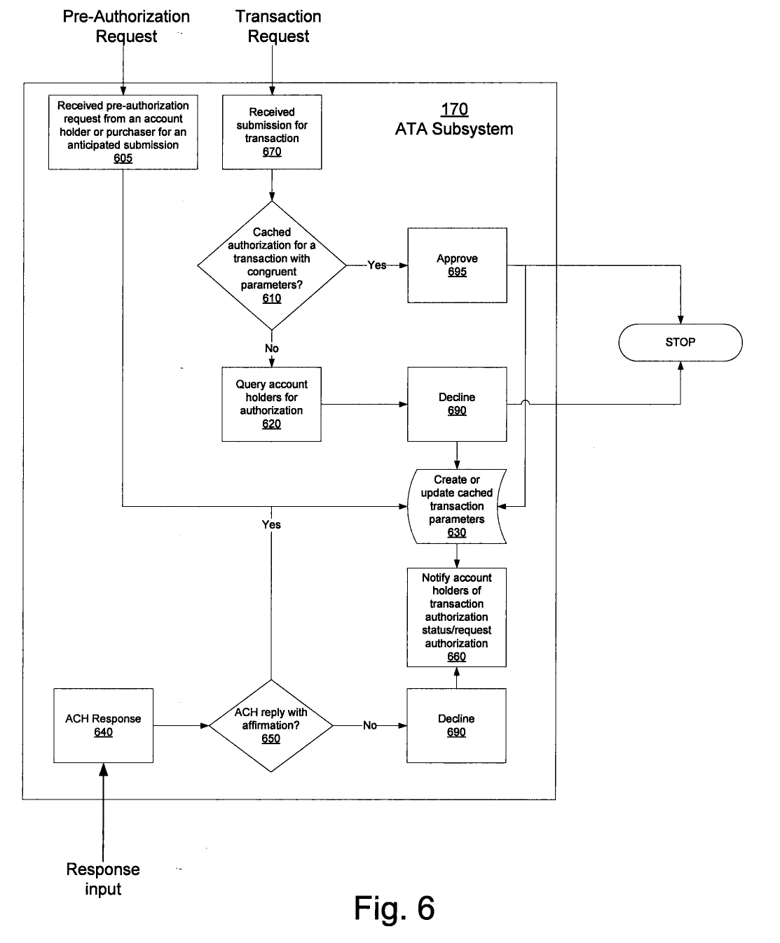

In order to provide further detail of the ATA process, FIG. 6 illustrates an exemplary ATA process, according to one embodiment. While FIG. 6 illustrates exemplary steps according to one exemplary embodiment, other embodiments may omit, add to, reorder, and/or modify any of the steps shown in FIG. 6.

As illustrated in FIG. 6, pre-authorization of any transaction may be given by any number of ACHs (180) to the ATA (170) before any transaction that exceeds a pre-defined threshold is approved (step 605) (if operating as a standalone clearing house) or through the CCN (150) or the CIB (160) as either an internal system to the CCN (150) or the CIB (160) or as an inline filter before or after the CCN (150) or the CIB (160) (step 610). Pre-authorization is initiated by a pre-authorization request, which may be submitted by a purchaser or an ACH(s) via an ACHD (320) (step 605). When a request for pre-authorization is provided for a transaction that exceeds the pre-determined threshold amount, the ATA (170) will create a new record and/or session with the anticipated transaction parameters (step 630), which may include, but is in no way limited to, the anticipated price of the transaction or a range within which the anticipated transaction will fall. Next, the ATA (170) will lookup whether or not authorization is needed by other ACHs (180), and either a notification of authorization or a request for authorization will be sent to the ACHs (180) step (660). In this exemplary embodiment, pre-authorization may be initiated by the ACHs (180) for a known transaction or it may be requested by a purchaser (110).

If, after analyzing the pre-authorization request, the ATA determines that authorization by additional ACHs is needed to meet the threshold authorizations, that authorization is sought (step 660) and upon receipt of the ACHs (180) authorization, (step 640), the ATA (170) will verify that the response was an affirmative authorization (step 650). If the response from the other needed ACHs is affirmative (yes, step 650), the ATA (170) updates the cached record of the anticipated transaction parameters (step (630). If, however, the response from the remaining ACHs (180) is negative or insufficient to meet the pre-determined number of ACHs approvals, authorization will be declined (No, step 690). Regardless of the authorization results, the ACHs and/or the purchaser may be notified of the results (step 660).

When the ATA (170) receives a submission for a transaction by a merchant (step (670), the ATA (170) will attempt query for an active (meaning not expired due to time delay) record which has been authorized and has congruent parameters with the received submission for transaction (step 610). If the ATA (170) finds a record corresponding to the received submission for transaction that has been authorized, the submission is said to have been anticipated and authorized, and is approved (step 695), and the record is updated (step 630). Thus if another transaction is attempted, for the same price, then the submission will be denied, since a transaction was already approved with the transaction parameters.

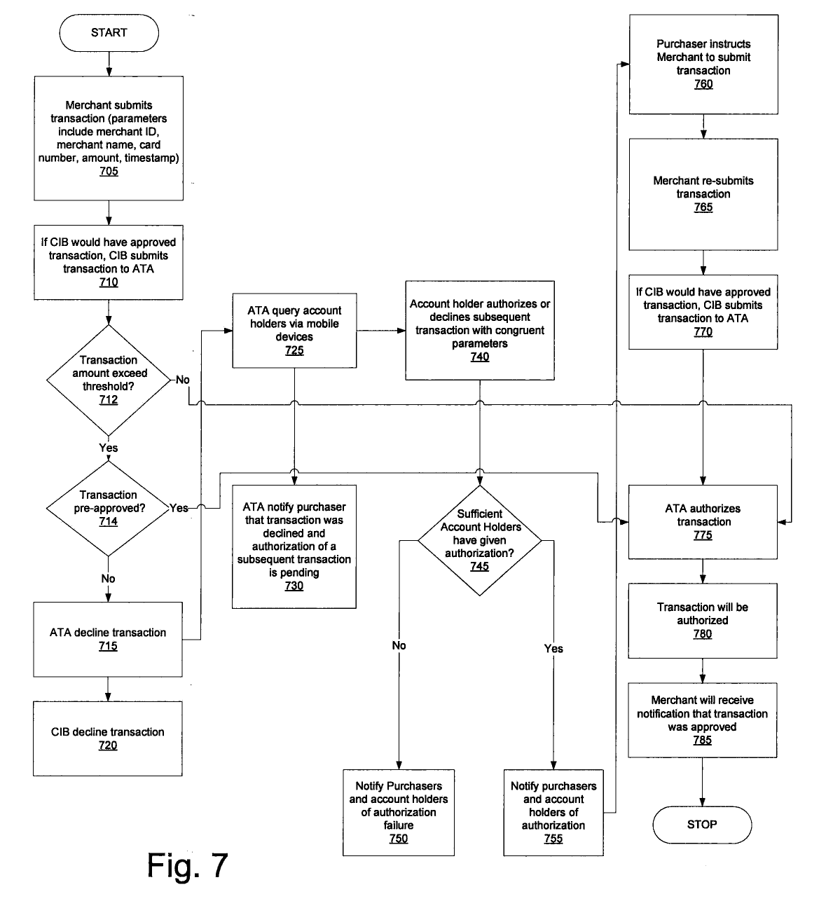

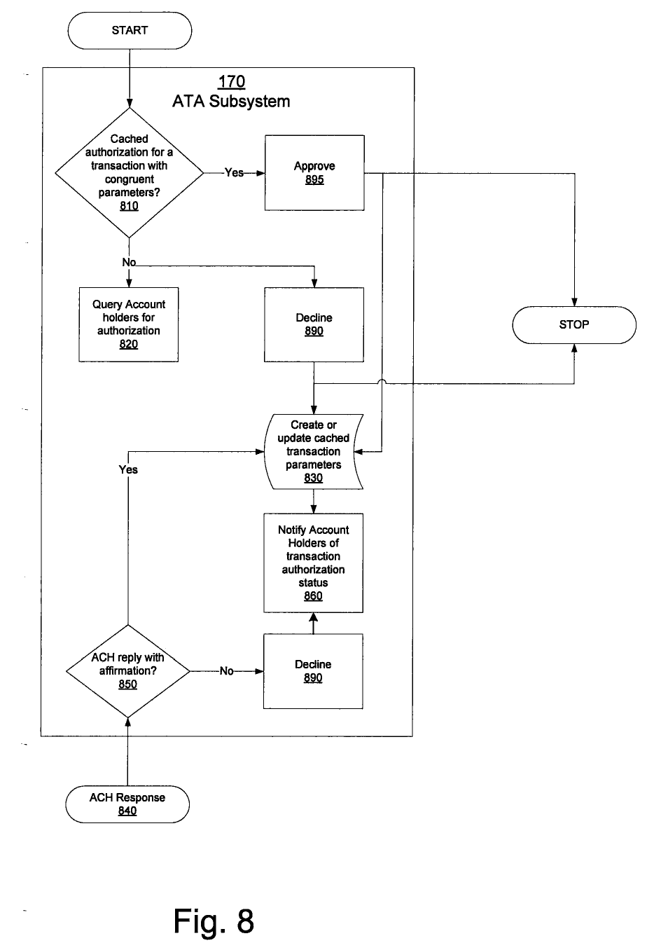

If, however, the ATA (170) receives a submission for a transaction exceeding the pre-defined threshold and finds no corresponding active record of authorization, then the ACHs (180) will be queried for authorization (No, step 620), and the submission will initially be declined (step 690). If there is no record of an authorization with parameters matching the submission parameters, then a record will be created with the submitted transaction's parameters (step 630). Then, the ACHs (180) will be notified of the transaction (step 660) to take remedial actions in the case of fraudulent activity, or to proceed with providing post transaction approval, as is detailed below with reference to FIGS. 7 and 8.

FIG. 7 illustrates an exemplary ATA process, according to one exemplary embodiment. While FIG. 7 illustrates exemplary steps according to one embodiment, other embodiments may selectively omit, add to, reorder, and/or modify the steps shown in FIG. 7.

FIG. 7 illustrates an exemplary ATA process, according to one exemplary embodiment. While FIG. 7 illustrates exemplary steps according to one embodiment, other embodiments may selectively omit, add to, reorder, and/or modify the steps shown in FIG. 7.

As noted above, purchasers may request a transaction, either unintentionally or as an alternative to pre-approval, that exceeds the predetermined threshold and that has not received pre-approval. Consequently, the transaction will be declined and post transaction approval will be sought. As shown in FIG. 7, a merchant (120) initially receives a request to complete a transaction and subsequently submits a transaction for approval by the CCN (150) CIB (160), and ATA (170) (step 705). The parameters in the submission made by the merchant (120) may include, but are in no way limited to the merchant's ID or name, amount of money requested for the purchase, credit card information, and a timestamp. The merchant ID is a number assigned to the merchant by the merchant's MSP (130). However, amongst larger merchants it is common to have several MSP (130) accounts for redundancy and failsafe mechanisms. Each MSP (130) can assign an arbitrary merchant id to each merchant (120). Therefore, since some merchants (120) may submit a transaction for approval using one MSP (130) and then use a different MSP (130) for a subsequent submission, the merchant name, as well as the merchant ID, may be equally important to track. The timestamp of the submission is used to ensure that a subsequent submission is within a predefined amount of time. Subsequent submissions that occur after the predefined time period will not be correlated or associated with each other, and will be treated as a separate purchases. While it is also likely that the ATA (170) may not rely on this timestamp, however, it may be useful for other features including but not limited to testing and data integrity metrics.

Once the transaction is submitted from the merchant (120), the CCN (150), CIB (160), and/or ATA (170) will receive the submission from the merchant (120). In the present example, for ease of explanation, the ATA will be described as residing on the CCN (150) and CIB (160), the ATA (170) may operate within, or as pre- or post-filter, or as a third-party. Furthermore, the ATA (170) is not restricted to any specific module or subsystem, and may be included, or communicated to, by any module or subsystem in the system (100). Therefore, the submission received may be carried to a separate network, or be executed on an existing network or system within any module or subsystem in the authorization system (100).

If the requested transaction does not exceed the predetermined threshold amount, the ATA will allow the transaction to pass through and be acted upon by the CCN (150) and the CIB (160) as processed by traditional systems.

However, if the transaction amount exceeds the predetermined threshold and no pre-approval has been sought, the ATA will be activated and the ATA will decline the first submission for a transaction (step 715). In conjunction with declining the first transaction, the ATA will also decline the submission for the proposed transactions to the CIB (step 720). The declined submission may be returned to any module which interfaces with the ATA (170), and may include but is in no way limited to the CCN (150) and the CIB (160). Declining of the first transaction while authorization is sought is significant in that it frees up the point of sale transaction components (such as credit card processing devices, PIN pads, cash registers, and the like) utilized by the merchant. This allows the merchant to continue to transact business while the present exemplary system seeks authorization. In contrast, traditional systems would take the entire bandwidth of the point of sale transaction components until approval/decline is received or the process times out. Traditional charge approval systems time out within seconds—much too quickly to allow for synchronous cardholder approval of a charge.

Additionally, the ATA (170) will query the account holder(s) via ACHDs (320). Prior to sending the query, the ATA (170) will store and maintain a record of the declined transaction submission. The ATA (170) may, but is not limited to, recording all the parameters discussed above in step 705 related to the declined submission. The record may also include a link to all associated ACHs (180) on the credit card. Furthermore, the record may also record the authorization or denial of each ACH (180). The record may be, but is not limited to, storage on an electronic storage device built to store and archive large segments of data, or an electronic storage device specifically built to create, recall, and update data quickly. Electronic storage devices which are specifically built for speed often provide a limited ability in the amount of data stored, however a caching mechanism using both types of devices may be useful for record keeping, and efficient processing of millions of submissions per minute world wide. The ATA (170) will send the query via the SMS (300), carrier network (310), or PMMDN (410) to the ACHs (180) for response (step 925). The query sent to the ACH (180) via the ACHD (320) may be transmitted via the cellular communication system (300), the proprietary mobile data and communication system (400), or any other communication system. As mentioned previously, the ATA queries the account holders via their mobile devices in order to obtain their authorization for the transaction that exceeded the predetermined threshold value. According to one exemplary embodiment the query received by the account and credit card holder (180) is in the form of an SMS message. Alternatively, the query may include embedded code that allows the ACH (180) to merely select a GUI (graphical user interface) button or other indicator to authorize the transaction.

Along with the query transmitted to the account and credit card holder (180), the ATA (170) may notify the purchaser (110) and/or the merchant that transaction submission was declined due to insufficient funds or another reason (step 730). Alternatively, the purchaser (110) associated with the card used may receive a message informing them that the transaction was declined only because authorization from ACHs (180) is pending (step 730). This step provides further card security in the case of an identity or card theft. Specifically, a person that steals a card or card number and then attempts a purchase that exceeds the predetermined threshold will only be notified by the merchant that the transaction did not go through. They will not receive the notice from the ATA (170) that authorization is pending. Consequently, the criminal attempting to misuse the card will likely assume that the theft had been reported and the card deactivated. Furthermore, other modules and subsystems may use the ATA to notify the purchaser (110) or the ACHs (180) of the status of the submitted transactions.

Once the appropriate queries and notices have gone out, the contacted ACH (180) authorizes or declines a subsequent transaction via an ACHD (320) (step 740). This process may, but is in no way limited to the following exemplary protocols. The ACH may respond to notification from step 725, with an affirmative SMS message containing the word “yes,” or “y,” a predefined keyword, a dynamic keyword provided in the query from step 725, a dynamic graphical user interface that simulates the clicking of a button, or any other forms of electronic acceptance or denial via the SMS (300), PMMDN (410), or proprietary applications defined prior to the ACH receiving the query (step 725).

After sending out the queries, the ATA (170) then awaits the responses from the ACHs. As illustrated in FIG. 7, the ATA (170) stores response from the ACH (180) to the query and determines if sufficient ACHs (180) have responded with authorization (step 745). According to one exemplary embodiment, the certification of an approval from the ACH (180) may be performed by matching an approval message with the ACH's corresponding phone number, by the receipt of a dynamically generated keyword or code that corresponds to the specific ACH and transaction, by the receipt of approval along with a cookie or other tracking kernel that may be associated with the response, and similar technologies. As noted previously, the present exemplary system and method may be configured to authorize a transaction exceeding a predetermined amount if a predetermined number of affirmative responses are received by the ATA. The appropriate amount of responses sufficient for authorization may be set by the user, and may also require authorization from the purchaser to prevent fraudulent transactions.

Regardless of whether the transaction is authorized or declined by the ACHs, a notification may be sent to the purchaser (180), and all other ACHs (180) that a sufficient number of ACH (180) has authorized or declined a subsequent submission of the transaction (step 750). Again, this notification may, according to one exemplary embodiment, be sent via SMS or MMS. In response to the authorization notice, the purchaser (110) or the ACHs (180) may then take appropriate and immediate action since they are on notice that the credit card is being used, whether fraudulently or without permission. Throughout this process funds remain protected.

When the ATA receives sufficient authorizations (Yes, step 745), the ATA may send a response to the purchaser (110) and all ACHs (180) that authorization of a subsequent transaction with similar parameters has been given (step 755).

As the purchaser is now notified that a subsequent transaction is authorized, the purchaser can (110) instruct the merchant (120) to resubmit transaction (step 760). When the transaction is again submitted by the merchant through the MSP (step 765), the afore mentioned parameters from step 705 should be the same, with the possible exception of the merchant ID for large merchants. If the parameters are not substantially the same, or are not re-submitted within a predefined amount of time, the subsequent transaction will also be declined.

If, however, the parameters of the subsequently submitted transaction are sufficiently similar to the originally submitted transaction (as compared by the ATA), and within a designated period of time, the ATA will authorize the transaction (step 770) and allow the CCN (150), CIB (160), or any other module or subsystem interfacing with the ATA (170) to verify that all other parameters are in line for approval of the transaction (step 775). The present exemplary system is described as requiring ATA approval of transaction exceeding the predetermined amount prior to passing the transaction on to the CCN (150) and/or CIB (160). However, as the ATA may be a standalone clearing house application or may be resident with the CCN or CIB, approval by the ATA may occur either prior to or after approval by the CCN and/or CIB.

Once approval is obtained by the ATA, the CCN, and the CIB, the transaction will be authorized and funds may be transferred to merchant account (step 780). Accordingly, the transaction will be approved at the point of sale and the merchant (120) will receive notification that the transaction has been approved and/or completed, similar to prior methods (step 785). Once completed, the purchaser may obtain the items being purchased.

In order to provide further detail of the ATA process, FIG. 8 illustrates an exemplary ATA process. While FIG. 8 illustrates exemplary steps according to one embodiment, other embodiments may omit, add to, reorder, and/or modify any of the steps shown in FIG. 8.

As illustrated in FIG. 8, submission of a transaction by the merchant (120) is given either directly to the ATA (if operating as a standalone clearing house) or through the CCN (150) or the CIB (160) as either an internal system to the CCN (150) or the CIB (160) or as an inline filter before or after the CCN (150) or the CIB (160) (step 810). Authorization of a transaction is requested when a merchant (120) submits a transaction for goods or services to be purchased by the purchaser (110). When a transaction is requested, a query may be performed to identify a prior submission according to the merchant's (120) id and/or name, price of the transaction, time the transaction parameter record was created, and current time minus delta. A delta is defined as a discrete amount of time from when the authorization was given and the time the subsequent submission. If delta is greater than a predefined period, then the record will not be identified as a prior submission. Otherwise, if the record includes authorization from all required ACHs (180), and delta is less than the predefined period, then the process proceeds to approve the transaction (step 895). If, however, no previous authorization has been provided, the ATA treats the authorization request as a new transaction and declines the transaction (step 890).

Upon declining a transaction, the ATA queries all ACHs (180) associated with the card used for the transaction, via text message, sent through an SMS aggregator's application programming interface (“API”) (step 820). SMS aggregators may also provide encryption services for further security. The query may, but is not limited to, include a unique keyword which ACHs must respond with to approve a subsequent submission. The query may also include, but is in no way limited to the parameters of the denied transaction, e.g. merchant (120) ID or name, total transaction price, card number, card holder name, date and time of transaction, and location.

The query in step 820 is stored as a transaction record in ATA's (170) electronic storage device and cache (step 830). Query parameters, and other parameters not listed may be stored as well.

When a response to the query is received from the ACH (step 840), via SMS aggregator API, the ATA (170) then determines if the response is an authorization or an indication of a desire to decline (step 850). If ATA (170) receives authorization (Yes, step 850), the corresponding transaction record is retrieved. Authorization from ACH is stored in the transaction record and notification of the ACH (180) approval is sent via the SMS aggregator (330) to purchaser (110) and other associated ACHs (180). If sufficient ACHs have granted approval then notification of approval is sent to purchaser (110) and all associated ACHs (180) to the transaction.

Conversely, if sufficient ACH replies are not received (No, step 850), the transaction is declined (step 890) and notification of such is sent to the ACHs (180) and purchaser (step 860). According to one exemplary embodiment, any time a transaction is declined, the declined submission may be routed to CIB (160) or any other source interfacing with the ATA.

When a transaction is approved by the ATA (step 895), the transaction is routed to the CIB (160), and the cached record may be deleted or marked as final, to prevent further transactions with similar parameters being approved. Approval may also be routed to any source interfacing with the ATA, e.g., CCN (150).

### IV. Alternative Embodiments

In addition to the above-mentioned systems and methods, a number of alternative embodiments may be incorporated. According to one alternative embodiment, the present system and method may not be limited to a single transaction. More particularly, the ATA can track the total spending by a purchaser associated with a credit card for a predetermined period of time. According to this exemplary embodiment, the ATA will continue to pass purchases through to the CCN and CIB for normal processing, so long as the predetermined threshold is not exceeded. However, when the predetermined threshold is exceeded for the identified period of time, the ATA will be activated and sufficient approval from the ACH will be required for subsequent authorizations during the designated time periods. It will be understood that, according to this exemplary embodiment, any time period may be designated including, but in no way limited to, a number of hours, days, weeks, months and/or years.

Additionally, according to one exemplary embodiment, pre-authorization may be obtained. According to this embodiment, a module on a handheld device may include instructions which, when accessed by a processor of the handheld device, enable said processor to receive images of bar-codes, interpret the bar-codes and correlate the bar-codes with a product and price, and calculate the transaction cost of purchasing the one or more items associated with the bar-code(s). The exemplary module may incorporate known bar-code and product correlation systems and methods commercially available, such as utilized in the RedLaser Iphone app by Occipital and other similar products. According to this alternative embodiment, when a purchaser has identified all the products they will be purchasing, the computer readable instructions can cause the processor to submit the anticipated charges to the ATA system (170) as an initial transaction exceeding the predetermined threshold amount so that authorization from sufficient ACHs (180) may be obtained.

### Alternative Security Features

Yet another exemplary embodiment of the present system and method may further reduce and/or eliminate the possibility of identify theft and fraud by incorporating security features in addition to the numerous features detailed above. For example, according to one exemplary embodiment, the above-mentioned systems and methods, may include, but are in no way limited to, at least a two part authorization process.

While the present exemplary system and method includes transmitting messages and authorizations wirelessly, it may be possible for a technically savvy criminal to assume an ACH's caller ID or hack into someone's network to assume their identification credentials. However, it is quite technologically difficult to intercept an SMS message directly to your phone, in order to perpetrate a fraud.

According to this exemplary embodiment, the ATA may request additional verification and/or confirmation after the initial pre-purchase authorization and confirmation was given, as detailed above. The confirmation message may include, but is in no ways limited to, the parameters of the anticipated or declined transaction, a note from the purchaser, a time period for which a code will be active, and a specific code that the ACH must copy and paste in a response to the ATA.

Specifically, according to one exemplary embodiment, the customer or ACH may send, via SMS, a request for pre-approval. In response, when the request has been granted, as described in detail above, the ATA sends confirmation including a code. When received, the customer cuts and pastes code into a second confirmation reply and sends the message (including the code) to the ATA. Upon receipt, the ATA confirms that the correct code has been received and sends a subsequent message detailing that x amount will be approved for the next y minutes. In sum, the exemplary system including enhanced fraud protection includes the sending of two SMS messages: one to initiate and provide pre-authorization, and a second to confirm the details sent back to them by the ATA system. Response to the second approval may be in any of the forms mentioned above, including, but in no way limited to, the transmission of a Y or a N, the selection of a GUI interface meant to simulate a physical button, the entry of a code in the response, and the like. An additional method that may be used independently or in combination with the double authentication method detailed above includes providing a predefined personal identification number (“PIN”) to each ACH. In this exemplary embodiment, the ACH (180) may previously receive or independently set a PIN, such that when an ACH (180) replies to a query for authorization, the ATA (170) will only accept authorization if the PIN associated with the transmitting ACH is included. An ACH (180) may also include the PIN in the original authorization. In order to circumvent this exemplary theft prevention, a thief must have the ACH's card and PIN, while spoofing the ACH's phone number. If the use of a PIN is implemented with the exemplary double authorization method, a thief would need the ACH's card, PIN, and phone to make any fraudulent charges.

Yet another exemplary embodiment, may include, but is in no way limited to, public/private key encryption. This could be implemented using the SMS (300) or PMCN (400). When the bank account is setup to use the ATA a private and public key is generated and placed on the respective devices and systems. Thereafter the query will only be readable by someone using a specific phone, and the response will also only be readable by the ATA.

The preceding exemplary views of the ATA, may be implemented as either pre- or post-transaction methods.

In the preceding exemplary views the ATA system includes authorizations by one or more ACHs (180), this may include, but is in no way limited to, situations where there are multiple ACHs and those ACHs are the parents of the purchaser (110), or a company where the ACHs (180) are officers or supervisors within that company and an employee is the purchaser (110). By requiring a certain level of authorization for purchases exceeding a predefined amount, the present exemplary system reinforces fiscal responsibility while providing account security and fraud protection.

Traditional transactional systems and methods have relied solely on possession of the credit card or credit card information to authorize transactions. However, such security measures have been proven to be unreliable, and do not provide the flexibility that families, groups, or companies may enjoy with the exemplary systems described or similar systems. The present exemplary system and method ensures that, despite the theft of a credit card or credit card information, the merchant (120), the ACHs (180) and purchasers (110) are protected from unauthorized charges. Furthermore, this method would not impose an unforeseen or unreasonable burden on merchants (120) or cause embarrassment for the purchaser (110) as they are accustomed to denial of an initial transaction, with the approval of a subsequent submission. Lastly the notifications transmitted to the purchaser (110) and ACHs (180) described in the exemplary system would allow the purchaser (110) to know and update the merchant (120) of the authorization progress of the intended transaction.

The preceding description has been presented only to illustrate and describe embodiments of the principles described herein. It is not intended to be exhaustive or to limit the disclosure to any precise form disclosed. The principles described herein may be practiced otherwise than is specifically explained and illustrated without departing from their spirit or scope. For example, the principles described herein may be implemented in a wide variety of authorization applications, including, but not limited to, security systems, online payment authorization, remote access protocols, etc. It is intended that the scope of the invention be defined by the following claims.

1. A credit theft prevention system, comprising:
a processor;
memory in electronic communication with the processor;
an asynchronous transaction authorization (“ATA”) module disposed on said memory, wherein said ATA module, when accessed by said processor, is configured to:
establish a predefined transaction threshold value;
receive a transaction pre-authorization request for a transaction exceeding said pre-defined transaction threshold value;
authorize said pre-authorization request when approval is received from at least one authorized cardholder;
receive transaction requests initiated with a credit card from a point of sale device;
compare said transaction requests to said predefined threshold value and said pre-authorized transactions;
pass said transaction through to a credit authorizing device when said transaction does not meet said predefined threshold value or when said transaction corresponds to a pre-authorized transaction; and
process said transaction when said transaction does meet said predefined threshold;
wherein processing said transaction includes:
recording data related to said transaction;
declining said transaction at said point of sale device;
requesting authorization for said transaction from at least one authorized cardholder associated with said credit card;
storing data associated with said authorization when said requested authorization is received;
prompting a purchaser to re-try said transaction;
receiving data associated with said re-try transaction;
comparing said data associated with said re-try transaction to data associated with said authorization; and
approving said transaction when said data associated with said re-try transaction is sufficiently similar to said data associated with said authorization.

2. The system of claim 1, wherein said ATA module, when accessed by said processor, is configured to request authorization for said transaction from at least one authorized cardholder associated with said credit card via SMS.

3. The system of claim 1, wherein said ATA module, when accessed by said processor, is configured to request authorization for said transaction from at least one authorized cardholder associated with said credit card via MMS.

4. The system of claim 1, wherein said ATA module, when accessed by said processor, is configured to request authorization for said transaction from at least one authorized cardholder associated with said credit card via SMTP.

5. The system of claim 1, wherein said request for authorization is encrypted.

6. The system of claim 1, further comprising prompting said purchaser to re-try said transaction when a pre-determined percentage of authorized cardholders associated with said credit card authorize said re-try transaction.

7. The system of claim 1, further comprising initiating a session when prompting a purchaser to re-try said transaction, wherein said session authorizes said transaction for a predefined time period.

8. The system of claim 1, wherein said receiving a transaction pre-authorization request for a transaction exceeding said pre-defined transaction threshold value comprises receiving a pre-authorization request for an expected transaction range.

9. The system of claim 1, wherein said ATA is further configured to, when accessed by said processor, grant pre-authorization only when said at least one authorized cardholder is identified either by keyword or a unique identification number.

10. The system of claim 9, wherein said ATA is further configured to request said keyword or unique identification number from said at least one authorized cardholder prior to passing said transaction through to a credit authorizing device when said transaction corresponds to a pre-authorized transaction.

11. The system of claim 1, wherein said ATA is further configured to obtain pre-authorization of said imminent transaction from a card issuing bank in response to said transaction pre-authorization request, said pre-authorization from said card issuing bank including transmitting said pre-authorization request to said card-issuing bank, receiving pre-approval of said imminent transaction from said card issuing bank, and notifying said purchaser and said account holder of said pre-authorization by said card issuing bank.

12. A credit theft prevention system, comprising:
a processor;
memory in electronic communication with the processor;
an asynchronous transaction authorization (“ATA”) module disposed on said memory, wherein said ATA module, when accessed by said processor, is configured to:
establish a predefined transaction threshold value;
receive a transaction pre-authorization request for a transaction exceeding said pre-defined transaction threshold value;
authorize said pre-authorization request when approval is received from at least one authorized cardholder;
receive transaction requests initiated with a credit card from a point of sale device;
compare said transaction requests to said predefined threshold value and said pre-authorized transactions;
pass said transaction through to a credit authorizing device when said transaction does not meet said predefined threshold value or when said transaction corresponds to a pre-authorized transaction; and
process said transaction when said transaction does meet said predefined threshold;
wherein processing said transaction includes:
declining said transaction at said point of sale device;
requesting authorization for said transaction from at least one authorized cardholder associated with said credit card;
prompting a purchaser to re-try said transaction;
approving said transaction when said data associated with said re-try transaction is sufficiently similar to said data associated with said authorization.

13. The system of claim 12, wherein said ATA module, when accessed by said processor, is configured to request authorization for said transaction from at least one authorized cardholder associated with said credit card via SMS.

14. The system of claim 12, wherein said ATA module, when accessed by said processor, is configured to request authorization for said transaction from at least one authorized cardholder associated with said credit card via MMS.

15. The system of claim 12, wherein said ATA module, when accessed by said processor, is configured to request authorization for said transaction from at least one authorized cardholder associated with said credit card via SMTP.

16. The system of claim 12, wherein said request for authorization is encrypted.

17. The system of claim 12, further comprising prompting said purchaser to re-try said transaction when a pre-determined percentage of authorized cardholders associated with said credit card authorize said re-try transaction.

18. The system of claim 12, further comprising initiating a session when prompting a purchaser to re-try said transaction, wherein said session authorizes said transaction for a predefined time period.

19. The system of claim 12, wherein said receiving a transaction pre-authorization request for a transaction exceeding said pre-defined transaction threshold value comprises receiving a pre-authorization request for an expected transaction range.

20. The system of claim 12, wherein said ATA is further configured to, when accessed by said processor, grant pre-authorization only when said at least one authorized cardholder is identified either by keyword or a unique identification number.

21. The system of claim 12, wherein said ATA resides with a card issuing bank (“CIB”).

22. A system configured to communicate with a point of sale device and a credit authorizing device over a data communication network, the system comprising:
a processor;
memory in electronic communication with the processor; and
an asynchronous transaction authorization (“ATA”) module disposed on said memory, wherein said ATA module is configured to:
receive requests from a purchaser for a pre-authorization of an imminent transaction initiated by a credit card;
receive pre-authorization from at least one account holder associated with said credit card;
notify said purchaser and said account holder of said pre-authorization;
receive and compare a transaction request to said pre-authorization;
pass said transaction request through to a credit authorizing device when said transaction request is received within a pre-defined amount of time and matches said pre-authorization; and
process said transaction when said transaction submission is not received within a pre-defined amount of time;
wherein processing said transaction includes:
recording data related to said transaction request;
declining said transaction at said point of sale device;
requesting authorization for said transaction from at least one authorized cardholder associated with said credit card;
prompting a purchaser to re-try said transaction;
approving said transaction when said data associated with said re-try transaction is sufficiently similar to said data associated with said authorization.

23. The system of claim 22, wherein the pre-authorization of an imminent transaction comprises the pre-authorization of a transaction range.

24. The system of claim 22, wherein said ATA module is further configured to: obtain pre-authorization of an imminent transaction by transmitting said pre-authorization request to a card issuing bank, receiving pre-approval of said imminent transaction from said card issuing bank, and notifying said purchaser and said account holder of said pre-authorization by said card issuing bank.
